(19) United States
(12) Patent Application Publication
(10) Pub. No.: US 2008/0193726 A1
(43) Pub. Date: Aug. 14, 2008

(54) DEVICE MANUFACTURING METHOD, LASER PROCESSING METHOD, AND LASER PROCESSING APPARATUS

(75) Inventors: Jungo Shimada, Kawasaki (JP); Fumihiko Tokura, Kawasaki (JP); Michinao Nomura, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/951,653

(22) Filed: Dec. 6, 2007

(30) Foreign Application Priority Data
Feb. 13, 2007 (JP) 2007-032475

(51) Int. Cl. B32B 3/00; B23K 26/02; B23K 26/38

(52) U.S. Cl. 428/195.1; 219/121.61; 219/121.67; 219/121.72; 219/121.82; 219/121.85

(57) ABSTRACT

A device manufacturing method is disclosed that includes the steps of moving a device at a constant speed while irradiating a laser beam on the device, and processing a part of the device with the laser beam.

### BACKGROUND OF THE INVENTION

1. Field of the Invention

The present invention relates to a method of manufacturing a small device, a laser processing method for processing parts of a small device using laser, and a laser processing apparatus implementing such a laser processing method.

2. Description of the Related Art

In accordance with the miniaturization of electronic apparatuses, there is a growing demand for miniaturization of small devices that are used in electronic apparatuses. In turn, processing techniques for enabling accurate processing of microscopic structures are in demand. As one example of a small device that is used in an electronic apparatus, a vibrating gyroscope may be installed in a car navigation system as an angular velocity sensor (gyro sensor), for example.

The vibrating gyroscope is a position detecting sensor that includes a vibrating tuning fork made of piezoelectric material as a sensor element and utilizes the Coriolis force acting on the vibrating tuning fork when the tuning fork is rotated to detect a current position. The tuning fork made of piezoelectric material has a drive electrode and an electrode used for vibration detection arranged next to each other. The electrode used for vibration detection outputs a voltage according to the vibration of the tuning fork. This output voltage is a sine wave having a waveform according to the vibration of the tuning fork. In order to maintain accurate detection performance, the effective value of the voltage waveform has to be controlled to be less than or equal to a reference value.

One exemplary method for adjusting the effective value of the voltage waveform involves changing the area of the electrode used for vibration detection. It is noted that although it is rather difficult to increase the area of an electrode, the area of an electrode may be easily reduced by cutting a portion thereof. Thus, in conventional practice, a relatively large electrode for vibration detection is initially installed in a gyro sensor, and the electrode is cut and adjusted to a suitable size afterwards by actually operating the gyro sensor and measuring its output voltage.

It is noted that laser trimming may be used as a processing method for cutting the electrode. Such a method involves irradiating a pulse laser on the electrode and shifting the laser irradiation position so that the electrode may be cut linearly to reduce its area. In one example, the laser trimming method may implement the galvano scanning scheme for irradiating laser on an electrode and shifting the laser irradiation position.

The galvano scanning scheme involves irradiating laser toward a processing object via two mirrors arranged on two different axes and passing the laser through a lens (fθ lens) to condense the laser on the processing object. According to this scheme, the processing position (laser condensing position) may be shifted at a high speed by driving and rotating the two mirrors. Specifically, by rotating the mirrors, the laser irradiation angle may be rapidly changed to enable high speed linear shifting of the laser condensing position of the processing object.

In another example, Japanese Laid-Open Patent Publication No. 63-129602 discloses a technique for successively performing sequential laser trimming on a processing object by successively conveying a processing object at a specified sequential speed and moving a probe and a laser beam back and forth within a processing section of the laser beam according to the moving speed of the processing object.

In another example, Japanese Laid-Open Patent Publication No. 2000-288753 discloses a laser trimming technique for moving a processing spot within a trimming region by moving a mask having an opening so that a laser beam passing through the opening to be incident to an objective lens may be moved.

In another example, Japanese Laid-Open Patent Publication No. 57-26408 discloses a laser trimming technique for moving a laser beam irradiating position by guiding the laser beam toward the vicinity of a desired position of a processing object using an optical fiber and minutely moving an objective lens arranged at the tip of the optical fiber.

FIG. 1 is a diagram showing an exemplary configuration of a conventional galvano scan optical system. In the illustrated optical system, a laser beam output from a laser oscillator 1 is reflected by mirrors 4 and 5 that are driven by drive systems 2 and 3, respectively, and is guided through a fθ lens 6 to be irradiated on a processing object 7. The laser beam output by the laser oscillator 1 may be a pulse laser such as a Q switch YAG laser that is condensed on the processing object 7 as a laser spot. It is noted that one laser spot may be formed by one laser pulse and the laser spot irradiating position may be successively moved to enable linear processing (cutting) of an electrode placed on a substrate, for example.

In such a galvano scan laser trimming process, since a laser beam is scanned on the processing object 7 via the mirrors 4 and 5 that are rotated by the drive systems 2 and 3, the processing accuracy depends on the resolution of the rotational angle of the mirrors 4 and 5. Also, since an optical component such as the fθ lens 6 is arranged between the mirrors 4, 5 and the processing object 7, the distance between the mirrors 4, 5 and the processing object 7 is relatively long so that the moving distance of the laser spot (condensing position on the processing object 7) is greater in relation to the moving distance (rotating distance) of the mirrors 4 and 5. Therefore, the processing position may not be accurately maintained in the case of implementing the galvano scan laser trimming method.

Also, it is noted that the galvano scan laser trimming method involves irradiating pulse laser on a processing electrode to successively form partially overlapping laser spots and removing portions of the electrode to create a linear processed portion (cut portion of electrode) formed by a continuous row of laser spots. Thus, when the processing position accuracy of the galvano scan laser trimming method is relatively low as is described above, adjacent laser spots may not adequately overlap one another in a desired manner during the laser trimming process so that portions that should be cut may be left behind (trimming failure).

Also, in the case of implementing the galvano scan laser trimming method, a relatively long distance has to be secured between the lens and the processing object in order to secure an adequate laser scanning area so that the focal length of the lens may become rather long. In this case, the laser spot diameter may only be reduced to about several dozen micrometers (μm) at the minimum. When the laser spot cannot be reduced to an adequately small size, damage to portions other than the processed portion of the processing object may be large, and this may be a problem particularly when the processing object is miniaturized.

### SUMMARY OF THE INVENTION

Aspects of the present invention are directed to providing a device manufacturing method, a laser processing method, and a laser processing apparatus that are adapted for accurately performing laser processing on a processing object such as a small device and reducing influences of the laser processing on the processing object.

According to one embodiment of the present invention, a device manufacturing method is provided that includes the steps of moving a device at a constant speed while irradiating a laser beam on the device, and processing a part of the device with the laser beam.

According to another embodiment of the present invention, a laser processing method is provided that includes the steps of generating a laser bema that is arranged to have a microscopic beam spot diameter, and moving a processing object at a constant speed to cause movement of an irradiation position of the laser beam with respect to the processing object at a fixed speed.

According to another embodiment of the present invention, a laser processing apparatus for processing a processing object is provided, the apparatus including a laser irradiation apparatus that generates a laser beam and irradiates the generated laser beam on the processing object, a moving stage that moves the processing object, and a control apparatus that controls operations of the laser irradiation apparatus and the moving stage, wherein the control apparatus controls the laser irradiation apparatus to irradiate the laser beam at a fixed power level and controls drive operations of the moving stage to move the processing object at a constant speed.

According to another embodiment of the present invention, a laser processing apparatus is provided that irradiates a laser beam on a processing object and cuts a component element of the processing object, the apparatus including a laser light source that generates a laser beam, a stage on which the processing object is mounted, a moving unit for inducing relative movement between the laser beam and the stage, and a control unit for controlling the moving unit to move the stage at a constant speed relative to the laser beam.

According to another embodiment of the present invention, a method is provided for manufacturing an electronic component having a surface on which an electrode is formed, the method including the steps of irradiating a laser beam on the electronic component in a perpendicular direction with respect to the electronic component, moving the electronic component being irradiated with the laser beam at a constant speed relative to the laser beam, and cutting the electrode formed on the electronic component with the laser beam.

According to another embodiment of the present invention, an electronic component is provided that includes a substrate and an electrode formed on a surface of the substrate, wherein at least a portion of the electrode is cut by a light beam that is irradiated on the electrode in a perpendicular direction with respect to the electrode while the light beam moves relative to the electrode at a constant speed.

In one aspect of the present invention, by realizing movement of a laser irradiation position through constant speed movement of a processing object, processing by laser irradiation may be accurately and reliably performed. More specifically, by moving the processing object rather than moving an optical system of a laser irradiation apparatus to induce movement of the laser irradiation position with respect to the processing object, accurate movement of the laser irradiation position may be realized.

In another aspect of the present invention, by moving the processing object to induce movement of the laser irradiation position with respect to the processing object, an optical system of a laser irradiation apparatus that is used may be simplified and microscopic laser spots may be formed with high accuracy so that functional degradation of the processing object due to heat generated by laser processing may be prevented, for example.

### BRIEF DESCRIPTION OF THE DRAWINGS

FIG. 1 is a diagram showing a configuration of a galvano scan laser irradiation apparatus;

FIG. 2 is a diagram illustrating a principle of a laser processing method according to an embodiment of the present invention;

FIGS. 3A and 3B are diagrams illustrating exemplary laser irradiation positions;

FIG. 4 is a diagram illustrating a trimming scar;

FIG. 5 is a perspective view of a laser processing apparatus according to an embodiment of the present invention;

FIG. 6 is a perspective view of a sensor element;

FIG. 7 is an enlarged plan view of a portion of the sensor element shown in FIG. 6;

FIG. 8 is a flowchart illustrating process steps of a laser trimming process performed by the laser processing apparatus shown in FIG. 5;

FIGS. 9A and 9B are diagrams showing exemplary waveforms of voltages output before and after performing the laser trimming process;

FIG. 10 is a plan view of an electrode showing a trimming process starting point; and

FIG. 11 is a cross-sectional view of the electrode shown in FIG. 10.

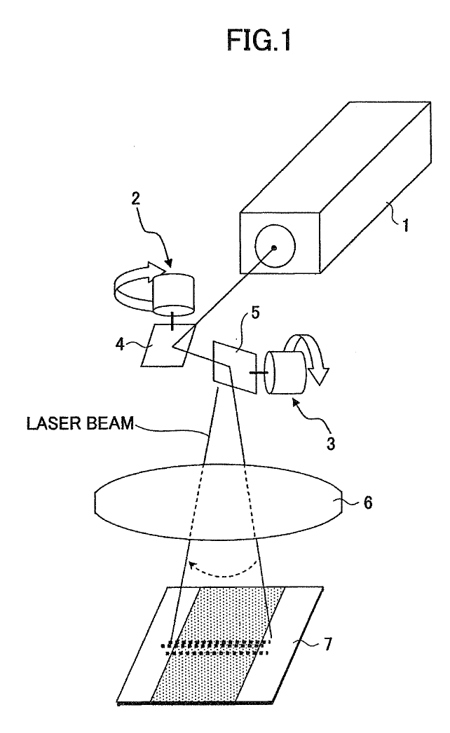

### DESCRIPTION OF THE PREFERRED EMBODIMENTS

In the following, preferred embodiments of the present invention are described with reference to the accompanying drawings.

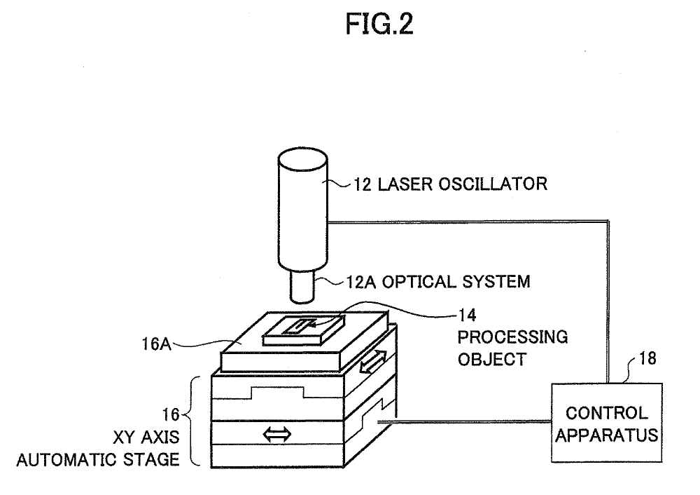

First, a principle of a laser processing method according to an embodiment of the present invention is described with reference to FIGS. 2 through 4.

FIG. 2 is a diagram showing a laser processing apparatus that performs a laser processing method according to an embodiment of the present invention.

The illustrated laser processing apparatus of FIG. 2 is particularly adapted for processing parts of a small device and includes a laser oscillator 12 that oscillates a laser beam and a XY axis automatic stage 16 that holds a processing object (work) 14 in place. It is noted that operations of the laser oscillator 12 and the XY axis automatic stage 16 are controlled by a control apparatus 18.

The laser oscillator 12 may be a laser such as a YAG laser that oscillates a laser beam having a relatively high power for enabling a portion of the processing object 14 to be instantly heated or cut. The laser beam output from the laser oscillator 12 is irradiated on the processing object 14 that is placed on a work mounting stage 16A of the XY axis automatic stage 16.

The XY axis automatic stage 16 is configured to move the work mounting stage 16A in X directions and Y directions with respect to a horizontal plane (XY plane) that is perpendicular to the optical axis of the laser beam output from an optical system 12A of the laser oscillator 12. Thus, by driving the XY axis automatic stage 16 to move the work mounting stage 16A in the X and Y directions, the processing object 14 mounted and fixed on the work mounting stage 16A may be moved in the X and Y directions.

The optical system 12A is configured to condense the laser beam from the laser oscillator 12 and irradiate the condensed laser beam on a processing portion of the processing object. It is noted that the present optical system 12A does not include a mechanism for vibrating and scanning a laser beam unlike an optical system used for implementing the galvano scan method. That is, the optical system 12A has a relatively simple structure primarily made up of an objective lens and is merely configured to condense and direct the laser beam output from the laser oscillator 12 onto the processing object 14. In one example, the optical system 12A may merely be configured to direct a laser beam toward an objective lens with an optical fiber.

It is noted that according to a conventional galvano scan method, a laser beam is condensed on a processing object via a fθ lens, and the laser beam is vibrated by an optical system in order to move the laser spot position. However, in the laser processing apparatus according to the present embodiment that is adapted for processing a small device, the laser beam condensing position (laser spot) is fixed and the processing object 14 is moved in order to change the laser spot position relative to the processing object 14.

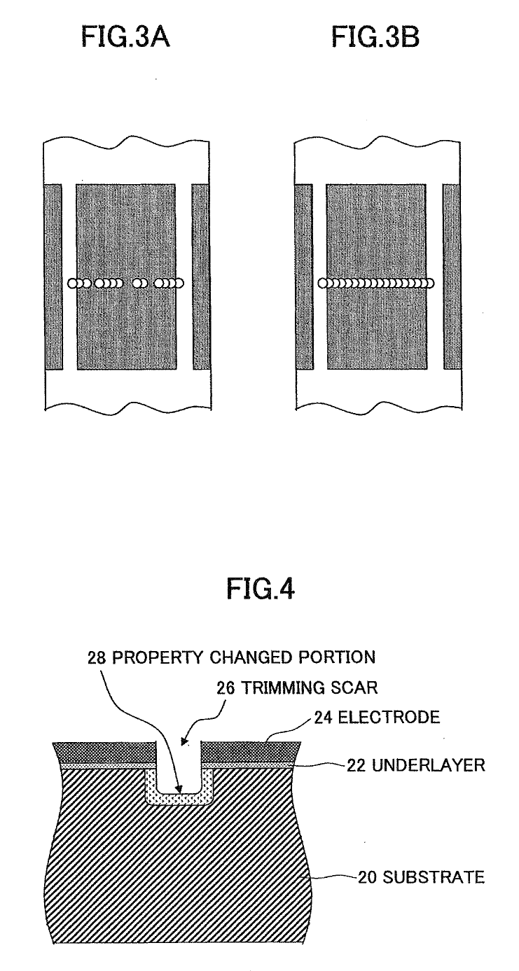

By fixing the laser beam condensing position and moving the processing object 14 as is described above, accurate laser processing may be realized. Specifically, in the galvano scan method, a laser beam is vibrated by an optical system to move the laser spot position, and in this case, a drive mechanism for driving and rotating a mirror of the optical system may not be able to drive the mirror with sufficient accuracy so that there may be variations in the pitch of successively formed laser spots as is shown in FIG. 3A. That is, certain adjacent laser spots may not overlap one another so that discontinuous portions, namely, portions that are not processed by laser, may be left behind on the processing object.

In contrast, FIG. 3B shows an exemplary processing result obtained in the case of implementing a laser processing method according to an embodiment of the present invention. As can be appreciated from this drawing, laser spots may be accurately arranged to overlap one another to form one row in the present example. It is noted that the XY axis automatic stage 16 uses a moving stage that has been developed in the field of semiconductor manufacturing to realize highly accurate movement. Thus, the XY axis automatic stage 16 may move the processing object 14 with high positioning accuracy and also control the moving speed of the processing object 14 with high accuracy. It is noted that by applying an embodiment of the present invention to current technology, the positioning accuracy tolerance of the moving stage may be reduced to approximately 5 μm or less, for example. As can be appreciated from the above descriptions, by implementing a laser processing method according to an embodiment of the present invention, the laser spot position with respect to the processing object 14 may be accurately controlled and movement of the laser spot relative to the processing object 14 may be accurately controlled as well.

Also, by implementing the laser processing method according to an embodiment of the present invention, a smaller laser spot may be formed compared to that formed in the galvano scan method. Specifically, in an optical system implementing the galvano scan method, an adequate distance has to be secured between the fθ lens and the processing object in order to enable scanning of the laser beam, and in turn, a relatively long focal length has to be secured. Therefore, the laser spot diameter may only be reduced to several dozen micrometers (μm). On the other hand, in laser processing apparatus implementing the laser processing method according to an embodiment of the present invention, the processing object 14 is moved while the laser beam condensing position is fixed at one point so that the optical system may be dedicated to condensing the laser beam. Accordingly, a smaller laser spot may be obtained. It is noted that by applying an embodiment of the present invention to current technology, a laser spot diameter of approximately 10 μm or less may be obtained, and in some cases, a laser spot diameter of approximately 5 μm may be obtained, for example.

As can be appreciated from the above descriptions, by implementing a laser processing method according to an embodiment of the present invention, a small laser spot may be used in laser processing so that influences of the laser processing on the small device being processed may be reduced. For example, as is shown in FIG. 4, in the case of cutting an electrode mounted on a substrate by laser processing, property change or damage may occur at a portion of the substrate close to the portion of the electrode that is processed (cut). The cross-sectional view of FIG. 4 shows a structure including a substrate 20, an underlayer 22 made of nickel (Ni) or some similar material, and a conductive layer as an electrode 24 that is made of gold (Au) or some similar material. It is noted that the illustrated structure of FIG. 4 has a trimming scar 26 formed at a portion where the electrode 24 has been processed and cut by laser spots. The trimming scar 26 reaches down to the substrate 20, and a property changed portion 28 is formed at the periphery of the trimming scar 26. The property changed portion 28 corresponds to a portion of the substrate 20 that has undergone property change owing to the heat generated by laser irradiation during laser processing. In a case where the substrate 20 is made of a piezoelectric material such as LT or LN, its function as a piezoelectric material may be lost as a result of the formation of the trimming scar 26 and the property changed portion 28, and in turn, the small device may lose its function as a sensor element, for example.

To reduce such influences of laser processing on the small device, the laser spot diameter is preferably arranged to be as small as possible to concentrate its power on a small area. Also, the laser spot is preferably irradiated only for a time period required for removing the electrode. In this respect, the laser processing method according to the present embodiment enables size reduction of the laser spot used for laser processing so as to reduce the influences of laser processing on a substrate upon performing laser processing on an element mounted on the substrate.

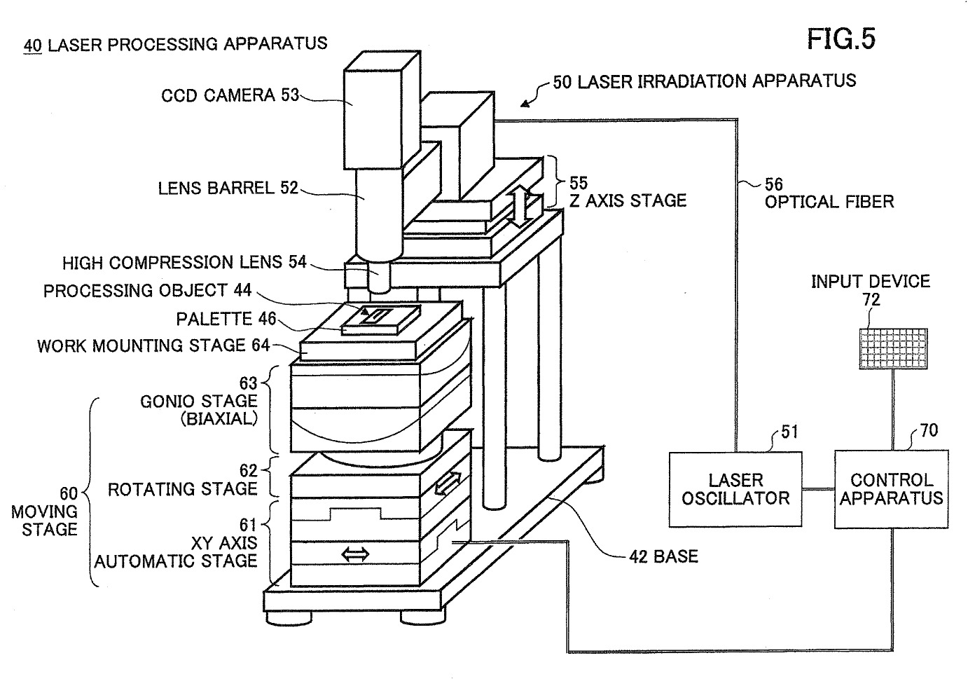

In the following, a laser processing apparatus according to an embodiment of the present invention is described with reference to FIG. 5.

FIG. 5 is a perspective view of a laser processing apparatus 40 according to an embodiment of the present invention.

The illustrated laser processing apparatus 40 of FIG. 5 includes a laser irradiation apparatus 50 and a moving stage 60 that are fixed to a base 42. The laser processing apparatus 40 is configured to have the laser irradiation apparatus 50 irradiate a laser beam on a processing object 44 that is mounted on the moving stage 60. It is noted that operations of the laser processing apparatus 50 and the laser irradiation apparatus 60 are controlled by a control apparatus 70, which is connected to an input device 72 that enables a user/operator to input various types of command signals to the control apparatus 70. For example, a user/operator may input a command signal to the control unit 70 via the input device 72 to control output operations of a laser oscillator 51, drive a Z axis stage 55 to adjust a focal point position, control image recognition operations of a CCD camera 53, and control drive operations of various component parts of the moving stage 60.

The laser irradiation apparatus 50 includes a laser oscillator 51, a lens barrel 52 that amplifies and outputs a laser beam, a CCD camera 53 as an imaging device that is arranged above the lens barrel 52, a high compression lens 54 that is arranged below the lens barrel 52, and a Z axis stage 55 for moving the lens barrel 52 in vertical directions (i.e., directions represented by the bidirectional arrow shown in FIG. 5). A laser beam output from the laser oscillator 51 is supplied to the lens barrel 52 via an optical fiber 56 after which the laser beam is amplified within the lens barrel 52 to be output to the high compression lens 54. The laser beam is then condensed into a microscopic laser spot by the high compression lens 54 to be irradiated on the processing object 44.

The CCD camera 53 arranged above the lens barrel 52 is configured to perform image recognition on the processing object 44 and convey the image recognition outcome to the control apparatus 70. The control apparatus 70 determines a laser irradiation position and a laser irradiation timing of a laser beam based on the image recognition outcome provided by the CCD camera 53, and drives component parts of the moving stage 60 to adjust the laser beam to be irradiated on an appropriate processing position of the processing object 44.

The lens barrel 52 may be moved in vertical directions by the Z axis stage 55 corresponding to a vertical moving mechanism. The high compression lens 54 may be moved in vertical directions along with the lens barrel 52 to adjust the focal point of the laser beam to a position on the processing object 44. It is noted that in an alternative embodiment, the Z axis stage 55 may be arranged below the moving stage 60 to move the moving stage 60 in vertical directions and adjust the laser beam focal point. However, the Z axis stage 55 is preferably arranged at the laser irradiation apparatus 50 since the laser irradiation apparatus 50 may be smaller and weigh less than the moving stage 60 so that the Z axis stage 55 may also be miniaturized.

The moving stage 60 includes a XY axis automatic stage 61 as a horizontal moving mechanism, a rotating stage 62 as a rotating mechanism that is arranged on the XY axis automatic stage 61, and a gonio stage 63 as a tiling mechanism. A work mounting stage 64 is placed on the gonio stage 63, and the processing object 44 is mounted on a palette 46, which is placed on and fixed to the work mounting stage 64.

By driving the XY axis automatic stage 61, the rotating stage 62 and parts arranged thereabove (i.e., the rotating stage 62, the gonio stage 63, the work mounting stage, the palette 46, and the processing object 44) may be moved in horizontal directions (XY directions). By driving the rotating stage 62, the gonio stage 63 and parts arranged thereabove may be rotated within a horizontal plane. Further, by driving the gonio stage 63, the work mounting stage 64 and parts arranged thereabove may be tilted with respect to a horizontal plane. Thus, by driving the respective parts of the moving stage 60, the processing object 44 placed on the palette 46 that is arranged on the work mounting stage 64 may be moved in X and Y directions and rotated to be set to a given position within a horizontal plane, and the processing object 44 may further be tilted in a given direction with respect to the horizontal plane. It is noted that in the present example, drive operations of the XY axis automatic stage 61, the rotating stage 62, and the gonio stage 63 are controlled by the control apparatus 70.

In the following, an exemplary processing object 44 is described. In the present example, it is assumed that the laser processing apparatus 40 shown in FIG. 5 is used to perform laser trimming on a sensor element of a small angular velocity sensor (vibrating gyroscope) that may be used in a car navigation system, for example.

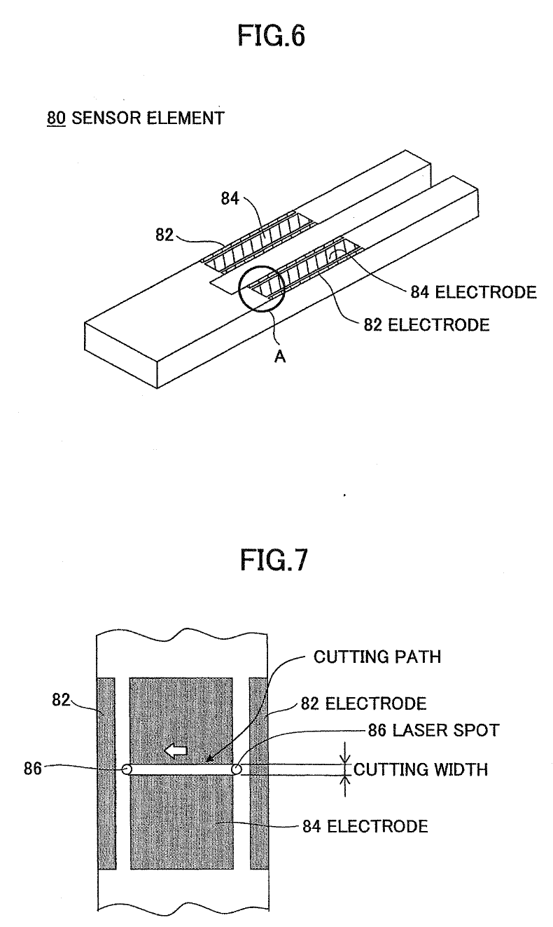

FIG. 6 is a perspective view of an exemplary sensor element 80 of a vibrating gyroscope. As is shown in FIG. 6, the sensor element 80 is a tuning fork made of piezoelectric material that has electrodes 82 and 84 arranged thereon. The electrode 82 is for applying a voltage that induces vibration of the tuning fork, and the electrode 84 is for detecting the vibration of the tuning fork. It is noted that the size (area) of the electrode 84 for detecting vibration has to be adjusted to a suitable size, and thereby, the electrode 84 is subject to laser processing (laser trimming). In the present example, it is assumed that the width of the electrode 84 is approximately 200 μm, and the electrode 82 is arranged adjacent to the electrode 84 at a pitch of approximately 30 μm. In such a case, laser trimming has to be performed with high accuracy.

FIG. 7 is an enlarged plan view of a portion A of the sensor element 80 shown in FIG. 6. As is shown in this drawing, two electrodes 82 are arranged adjacent to the two lateral sides of the electrode 84. It is noted that while the electrode 84 for detecting vibration has to be cut and processed through laser trimming, the electrodes 82 arranged at the sides of the electrode 84 are not subject to such laser processing. Moreover, laser trimming of the electrode 84 is preferably performed in a manner such that the electrodes 82 may be protected from influences of the laser trimming process.

Laser trimming of the electrode 84 is performed using the laser processing apparatus 40 to irradiate a laser beam along a predetermined linear position of the electrode 84 and cut a portion of the electrode 84. Specifically, as is shown in FIG. 7, laser spots 86 are scanned on the electrode 84 to cut the electrode 84. That is, the moving path of the laser spot 86 corresponds to the cutting path, and the diameter of the laser spot 86 corresponds to the cutting width. It is noted that the arrow shown in FIG. 7 represents the scanning direction of the laser spot 86, namely, the cutting direction.

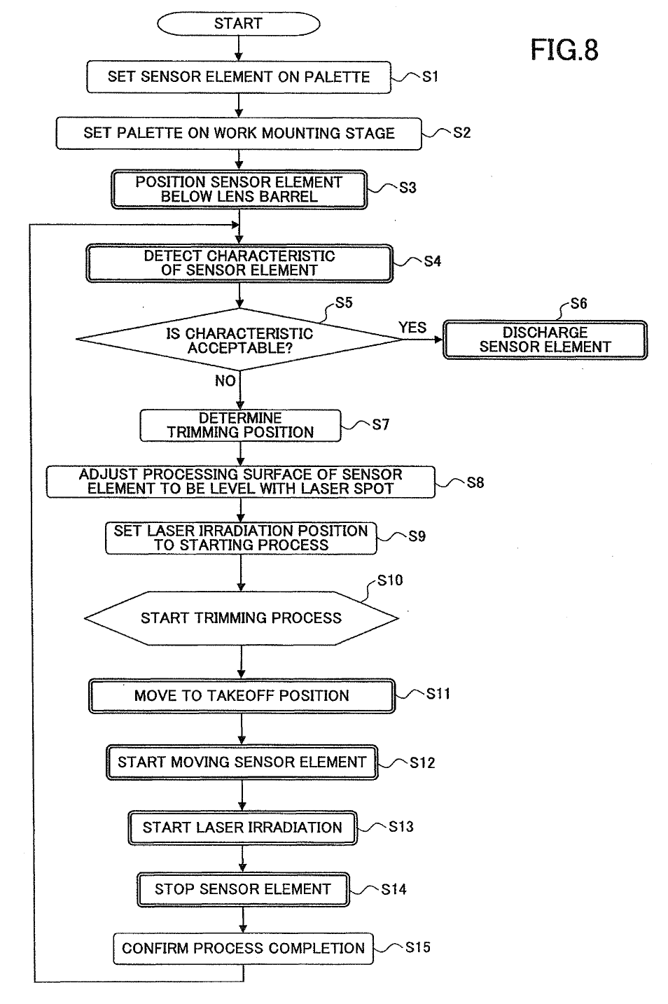

In the following, an exemplary laser processing method performed by the laser processing apparatus 40 shown in FIG. 5 is described with reference to FIG. 8.

FIG. 8 is a flowchart showing process steps for cutting the electrode 84 shown in FIG. 7 through laser trimming performed by the laser processing apparatus 40 shown in FIG. 5.

According to FIG. 8, first, in step S1, the sensor element 80 as the processing object 44 is placed on the palette 46. Then, in step S2, the palette 46 is mounted and fixed on the work mounting stage 64. Then, in step S3, the moving stage 60 is driven to move the sensor element 80 to a predetermined position below the lens barrel 52.

Then, in step S4, a characteristic of the sensor element 80 is detected. In the present example, it is assumed that the voltage output from the electrode 84 of the sensor element 80 corresponds to the characteristic of the sensor element to be detected in step S4. Specifically, a voltage is applied to the electrode 82 of the sensor element 80 to induce vibration of the sensor element 80 and the electrode 84 outputs a voltage in response to the vibration of the sensor element 80 which output voltage is detected in step S4. As is described in detail below, when the effective value of the voltage output by the electrode 84 is within a specified range, it may be determined that the sensor element 80 meets its specifications.

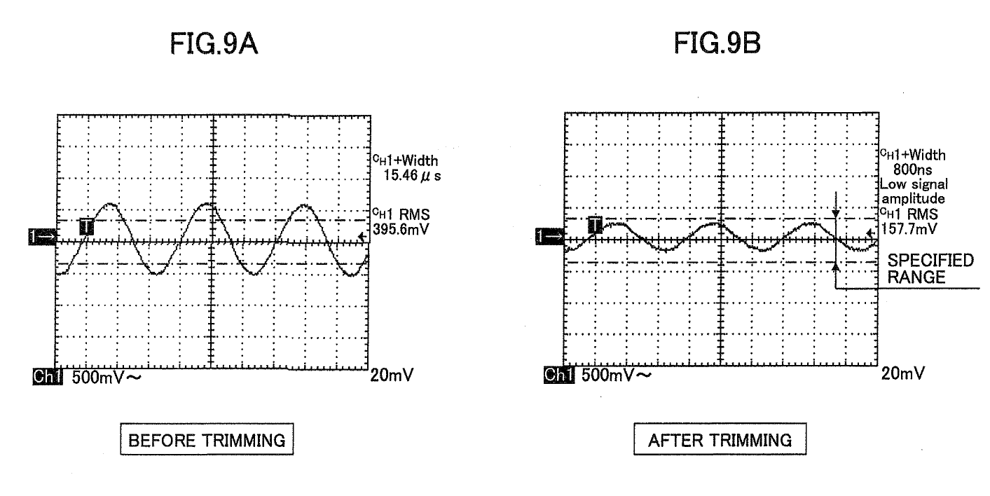

FIGS. 9A and 9B are diagrams illustrating exemplary waveforms of voltages output by the electrode 84. FIG. 9A shows an exemplary waveform of a voltage output by the electrode 84 that is not yet adjusted. The effective value of the voltage output by the electrode 84 in this case exceeds the specified range. It is noted that the voltage output by the electrode 84 may be proportional to the area of the electrode 84. Thus, a portion of the electrode 84 may be cut to reduce the area of the electrode 84 so that the effective value of the voltage output by the electrode 84 may be reduced to be within the specified range as is shown in FIG. 9B. Such a process of cutting a portion of the electrode 84 may be realized by a laser trimming process performed by the laser processing apparatus 40.

After detecting the characteristic of the sensor element 80 in steps S4, a determination is made as to whether laser trimming has to be performed on the electrode 84 in step S5. Specifically, if the effective value of the voltage output by the electrode 84 is within the specified range, adjustment of the electrode 84 is unnecessary, and the process may move on to step S6 in which the sensor element 80 is discharged from the laser processing apparatus 40 so that preparations may be made for processing a next processing object 44 at the laser processing apparatus 40.

On the other hand, if the effective value of the voltage output by the electrode 84 exceeds the specified range, adjustment of the voltage output by the electrode 84 has to be performed, and the process moves on to step S7 in which preparatory operations are performed for starting a laser trimming process.

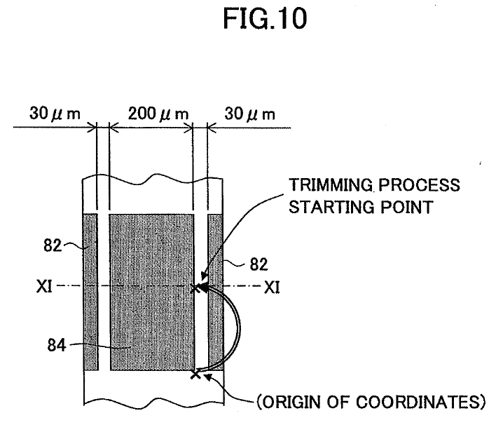

Specifically, in step S7, a trimming position of the electrode 84 is determined in a manner described below. First, an edge of the sensor element 80 is detected by capturing an image of the electrode 84 using the CCD camera 53 corresponding to an imaging device, and a corner point of the detected edge of the electrode 84 is set as an origin of coordinates as is shown in FIG. 10. Then, based on the characteristic (i.e., output voltage) of the electrode 84 detected in step S4, the position at which the electrode 84 is to be cut is determined. It is noted that the control unit 70 stores information indicating the relationship between a cutting position of the electrode 84 and the effective value of the voltage output by the electrode 84 that is cut at the corresponding cutting position. In this way, a suitable cutting position at which the electrode 84 may be cut to adjust the output voltage within the specified range may be determined based on the detection result obtained in step S4. It is noted that in the illustrated example of FIG. 10, a trimming process starting point is determined as the cutting position at which the electrode 84 is to be cut.

After determining the coordinate position of the trimming process starting point (the cutting position) in step S7, the process moves on to step S8 in which the Z axis stage 55 is driven to move the electrode 84 toward a focal point position so that the laser spot may be level with the processing surface of the sensor element 80 (surface of the electrode 84) and the gonio stage 63 is driven to adjust the tilting angle of the sensor element 80 with respect to the horizontal plane in order to maintain the focal point position on the electrode 84 throughout the cutting width of the electrode 84. That is, in driving the moving stage 60 to move the sensor element 80, the angle of the sensor element 80 is adjusted so that the focal point of the laser beam being irradiated thereon may always be positioned on the electrode 84.

Then, in step S9, the XY axis stage 61 and the rotating stage 62 are driven so that the laser irradiation position may be set to the cutting position of the electrode 84 (i.e., trimming process starting point) determined in step S7. In this way, preparations for performing the laser trimming process may be completed, and the process may move on to step S10 in which the laser trimming operations are started.

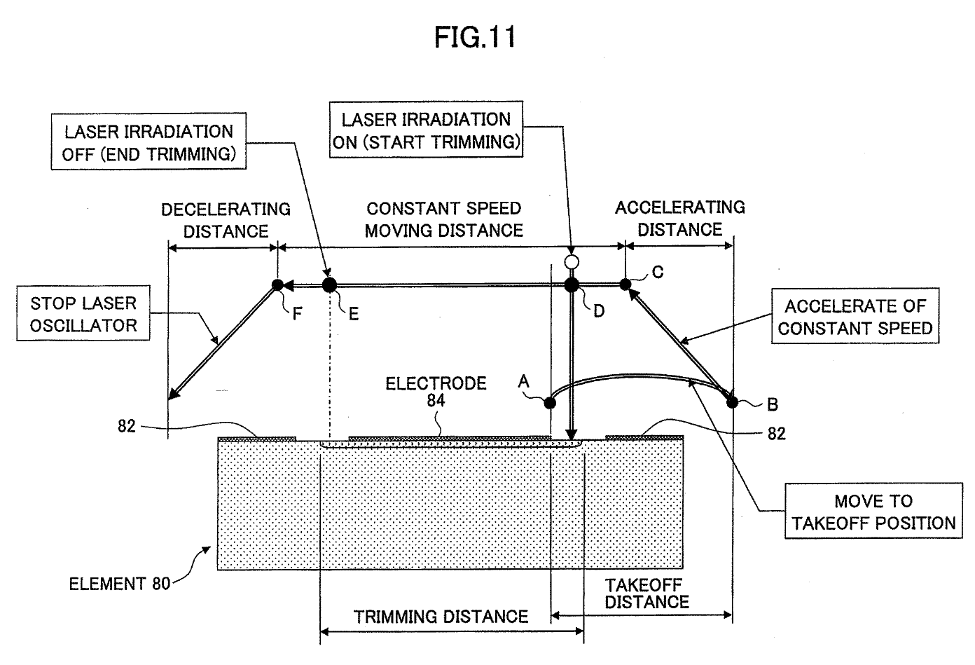

When the laser trimming operations are started, first, in step S11, the XY axis stage 61 is driven to move the electrode 84 to a takeoff position. The takeoff position may be a position to which the laser irradiation position is shifted from the trimming process starting point by a predetermined distance in an opposite direction with respect to the cutting direction. FIG. 11 is a cross-sectional view of the sensor element 80 cut along line XI-XI of FIG. 10 illustrating the movement of the laser spot position. It is noted that in actual practice, the sensor element 80 is moved to cause relative positional movement of the laser irradiation position (laser spot) with respect to the electrode 84; however, in FIG. 11, such relative positional movement is illustrated as though the laser irradiation position is moved for the sake of convenience.

When the laser irradiating position reaches the takeoff position (position B shown in FIG. 11), the process moves on to step S12 in which the XY axis automatic stage 61 is driven so that the sensor element 80 may start moving. Specifically, the sensor element 80 is moved in the direction opposite the cutting direction so that the laser irradiation position may advance in the cutting direction relative to the sensor element 80. It is noted that at this point a laser beam is not yet irradiated.

After the sensor element 80 moves a predetermined distance, the moving speed of the sensor element 80 may be stabilized to a constant speed. Specifically, when moving operations of the sensor element 80 are started by the XY axis automatic stage 61, the moving speed of the sensor element 80 is accelerated until the sensor element 80 moves a predetermined distance. Then, the sensor element 80 starts moving at a constant speed. It is noted that the laser irradiation position at which the sensor element 80 starts moving at a constant speed (point C of FIG. 11) is still outside the electrode 84 (laser processing portion).

When the sensor element 80 reaches point D of FIG. 11, that is, after the sensor element 80 starts moving at a constant speed but before the laser irradiation position reaches the edge of the electrode 84, the process moves on to step S13 in which laser irradiation is started. Accordingly, a laser spot is generated on the sensor element 80 at a position just in front of the edge of the electrode 84 and laser trimming of the electrode 84 is hereby started. It is noted that the constant speed movement of the sensor element 80 by the XY axis automatic stage 61 is maintained even after laser irradiation is started. Therefore, laser spots are formed on the electrode 84 at equidistant intervals to overlap each other (see FIG. 3B) so that the electrode 84 may be accurately and reliably cut.

After the electrode 84 is completely cut, that is, after the laser irradiation position moves at a constant speed for a predetermined distance relative to the sensor element 80 to reach point E shown in FIG. 11, laser irradiation is terminated. Then, at point F shown in FIG. 11, deceleration of the XY axis automatic stage 61 is started and laser oscillation by the laser irradiation apparatus 50 is terminated. Then, the process moves on to step S14 in which the sensor element 80 is stopped after moving at a decelerated speed for a certain distance.

The laser trimming process is then ended and the electrode 47 is cut at the position determined in step S7. In step S15, confirmation is made of the completion of the laser trimming process, and the process goes back to step S4.

In step S4, the characteristic of the sensor element 80 is detected once more. It is noted that the area of the electrode 84 is reduced as a result of having its portion cut by the laser trimming process, and therefore, the effective value of the output voltage of the electrode 84 is presumably within the specified range. If it is determined in step S5 that the effective value of the output voltage of the electrode 84 is within the specified range, it is determined that the output voltage adjustment of the sensor element 80 has been successfully completed and the process moves on to step S6 where the sensor element 80 is discharged from the laser processing apparatus 40 so that preparations may be made for processing a next processing object 44 at the laser processing apparatus 40.

On the other hand, if it is determined in step S5 that the effective value of the voltage output from the electrode 84 exceeds the specified range for some reason, readjustment of the output voltage of the electrode 84 has to be performed and the process moves on to step S7 where a laser trimming process is performed once again. That is, the above-described process steps for performing the laser trimming process are repeated.

It is noted that in one embodiment, laser processing conditions such as the processing speed (constant speed), the accelerating speed until reaching the processing speed, the takeoff distance, the laser irradiation timing, the timing deviation correction distance, the laser output, the laser pulse width, the pulse peak value, and the pulse frequency may be automatically set by the control unit 70. In another embodiment, such laser processing conditions may be set or changed by a user inputting relevant command signals to the control unit 70 via the input device 72, for example.

The above-described adjustment process of the sensor element 80 through laser trimming may be performed as a part of a process for manufacturing a small device such as a vibrating gyroscope, for example. That is, the process illustrated in FIG. 8 may be a part of a small device manufacturing process.

As can be appreciated from the above descriptions, according to an embodiment of the present invention, the laser irradiation position on the sensor element 80 may be moved by driving the XY axis automatic stage 61 and moving the sensor element 80 at a constant speed throughout the cutting position range of the electrode 84. In this way, intervals between laser spots formed on the electrode 84 may be accurately controlled to be equidistant. In turn, the electrode 84 may be reliably and accurately cut by laser irradiation. Specifically, when the intervals between laser spots vary, portions between laser spots that are desirably cut may be left behind; however, such cases may be avoided in the present embodiment so that reliable and accurate laser trimming may be enabled. It is noted that in conventional practice, the laser irradiation position with respect to a processing object is moved by moving an optical system of a laser irradiation apparatus; however, according to the present embodiment, the sensor element 80 as the processing object is moved by driving the XY axis automatic stage 61 so that the laser irradiation position may be accurately moved relative to the sensor element 80.

Also, it is noted that by moving the sensor element 80 to cause relative movement of the laser irradiation position rather than moving an optical system of a laser irradiation apparatus to move the laser irradiation position, the optical system (e.g., high compression lens 54) of the laser irradiation apparatus 50 used in the present embodiment may be simplified so that it may be dedicated to realizing accurate formation of small laser spots. For example, the high compression lens 54 may be configured to have a small numerical aperture but a high concentration ratio so that the laser spot diameter at the focal point may be reduced to approximately 10 μm or less. In this way, laser processing accuracy may be improved and influences of the laser irradiation on areas close to the laser irradiation position may be reduced. For example, generation of trimming scars at portions other than the electrode 84 of the sensor element 80 (e.g., base material of the sensor element 80) may be prevented upon performing laser irradiation and property changed portions formed around the trimming scars due to heat of the laser irradiation may be reduced. In turn, degradation of the functions of the sensor element 80 due to heat generated by the laser irradiation may be prevented.

It is noted that in the above-described embodiments of the present invention, the sensor element 80 is used as the processing object 44; however, the processing object 44 subject to laser processing according to an embodiment of the present invention is not limited to a sensor element of a vibrating gyroscope and elements of various other types of small devices may equally be subject to a laser processing method according to the present invention. Also, it is noted that laser processing according the present invention is not limited to a laser cutting process as is described above, and may also include other processing techniques such as a laser bending process that involves irradiating a laser beam to cause thermal deformation of an element, for example.

Further, the present invention is not limited to these embodiments, and variations and modifications may be made without departing from the scope of the present invention.

The present application is based on and claims the benefit of the earlier filing date of Japanese Patent Application No. 2007-032475 filed on Feb. 13, 2007, the entire contents of which are hereby incorporated by reference.

What is claimed is:

1. A device manufacturing method comprising the steps of:
moving a device at a constant speed while irradiating a laser beam on the device; and
processing a part of the device with the laser beam.

2. The device manufacturing method as claimed in claim 1, wherein
the laser beam is irradiated at a fixed position while the device is moved to cause movement of a laser irradiation position with respect to the device.

3. The device manufacturing method as claimed in claim 1, wherein
the laser beam is a pulse laser; and
the processing step involves forming a plurality of laser spots at equidistant intervals on a laser processing portion of the device.

4. The device manufacturing method as claimed in claim 1, wherein
the device is a sensor device.

5. The device manufacturing method as claimed in claim 4, wherein
the sensor device is a gyro sensor; and
the part of the device that is processed corresponds to an electrode formed on a sensor element of the gyro sensor.

6. The device manufacturing method as claimed in claim 5, wherein
the processing step involves cutting the electrode using the laser beam.

7. A laser processing method comprising the steps of:
generating a laser beam that is arranged to have a microscopic beam spot diameter; and
moving a processing object at a constant speed to cause movement of an irradiation position of the laser beam with respect to the processing object at a fixed speed.

8. The laser processing method as claimed in claim 7, further comprising the steps of:
using a pulse laser as the laser beam and forming a plurality of laser spots on the processing object at equidistant intervals.

9. The laser processing method as claimed in claim 8, further comprising the step of:
controlling a power of the laser beam to a fixed level.

10. The laser processing method as claimed in claim 7, further comprising the steps of:
securing a takeoff distance over which the processing object is to be moved before the irradiation position of the laser beam reaches a laser processing portion of the processing object; and
accelerating a moving speed of the processing object to the constant speed while moving the processing object over the takeoff distance.

11. The laser processing method as claimed in claim 10, wherein
irradiation of the laser beam is started after the moving speed of the processing object is accelerated to the constant speed.

12. The laser processing method as claimed in claim 10, wherein
after the moving speed of the processing object is accelerated to the constant speed, the processing object continues to be moved at the constant speed until the irradiation position of the laser beam moves outside the laser processing portion of the processing object.

13. The laser processing method as claimed in claim 7, further comprising the steps of:
recognizing an image of the processing object;
determining a laser processing start position based on an outcome of recognizing the image of the processing object; and
moving the processing object to the laser processing start position before starting the step of moving the processing object at the constant speed.

14. The laser processing method as claimed in claim 7, wherein
the processing object is a sensor element of a gyro sensor, and an electrode formed on the sensor element is cut using the laser beam.

15. A laser processing apparatus for processing a processing object, the apparatus comprising:
a laser irradiation apparatus that generates a laser beam and irradiates the generated laser beam on the processing object;
a moving stage that moves the processing object; and
a control apparatus that controls operations of the laser irradiation apparatus and the moving stage; wherein
the control apparatus controls the laser irradiation apparatus to irradiate the laser beam at a fixed power level and controls drive operations of the moving stage to move the processing object at a constant speed.

16. The laser processing apparatus as claimed in claim 15, wherein
the laser irradiation apparatus includes an imaging device that recognizes an image of a laser processing portion of the processing object and conveys an outcome of recognizing the image to the control apparatus.

17. The laser processing apparatus as claimed in claim 15, wherein
the laser irradiation apparatus includes a vertical moving mechanism that is configured to move an optical system for outputting the laser beam in vertical directions and adjust a focal point position of the laser beam.

18. The laser processing apparatus as claimed in claim 15, wherein the moving stage includes
a work mounting stage on which the processing object is mounted;
a tilting mechanism configured to tilt the work mounting stage with respect to a horizontal plane;
a rotating mechanism that rotates the tilting mechanism within the horizontal plane; and
a horizontal moving mechanism that moves the rotating mechanism within the horizontal plane.

19. The laser processing apparatus as claimed in claim 15, further comprising:
an input device for inputting a command signal to the control apparatus.

20. A laser processing apparatus that irradiates a laser beam on a processing object and cuts a component element of the processing object, the apparatus comprising:
a laser light source that generates a laser beam;
a stage on which the processing object is mounted;
a moving unit for inducing relative movement between the laser beam and the stage; and
a control unit for controlling the moving unit to move the stage at a constant speed relative to the laser beam.

21. The laser processing apparatus as claimed in claim 20, wherein
the control unit controls the laser beam to be irradiated at a fixed output level while the stage is being moved at the constant speed.

22. The laser processing apparatus as claimed in claim 20, wherein
the stage is moved relative to the laser beam within a plane that is perpendicular to an optical axis of the laser beam being irradiated on the processing object.

23. The laser processing apparatus as claimed in claim 20, wherein
the laser light source is fixed; and
the stage is configured to move within a plane that is perpendicular to an optical axis of the laser beam.

24. The laser processing apparatus as claimed in claim 20, wherein
the laser light source includes a compression lens that reduces a beam spot diameter of the laser beam being irradiated.

25. The laser processing apparatus as claimed in claim 20, wherein
the laser processing apparatus includes an imaging device that captures an image of the processing object; and
the control unit controls the moving unit based on an outcome of capturing the image of the processing object by the imaging device.

26. The laser processing apparatus as claimed in claim 20, further comprising:
a detection unit that detects a characteristic of the processing object;
wherein the control unit controls the moving unit based on the characteristic of the processing object detected by the detection unit.

27. The laser processing apparatus as claimed in claim 20, wherein
the laser light source is a fiber laser.

28. A method of manufacturing an electronic component having a surface on which an electrode is formed, the method comprising the steps of:
irradiating a laser beam on the electronic component in a perpendicular direction with respect to the electronic component;
moving the electronic component being irradiated with the laser beam at a constant speed relative to the laser beam; and
cutting the electrode formed on the electronic component using the laser beam.

29. The method as claimed in claim 28, further comprising the steps of:
starting relative movement between the electronic component and a light source that irradiates the laser beam; and
starting irradiation of the laser beam from the light source when a relative moving speed between the electronic component and the light source reaches a predetermined speed.

30. An electronic component comprising:
a substrate; and
an electrode formed on a surface of the substrate;
wherein at least a portion of the electrode is cut by a light beam that is irradiated on the electrode in a perpendicular direction with respect to the electrode while the light beam moves relative to the electrode at a constant speed.

31. The electronic component as claimed in claim 30, comprising
at least a part of a sensor device.
